(19) United States
(12) Patent Application Publication
(10) Pub. No.: US 2021/0177034 A1
(43) Pub. Date: Jun. 17, 2021

(54) APPARATUS FOR PEELING A MANGO

(71) Applicant: TURATTI S.R.L., Venezia (IT)

(72) Inventor: Antonio TURATTI, Venezia (IT)

(21) Appl. No.: 16/759,292

(22) PCT Filed: Oct. 24, 2018
(86) PCT No.: PCT/IT2018/050206

§ 371 Date: Apr. 24, 2020

(30) Foreign Application Priority Data
Oct. 26, 2017 (IT) 102017000121906

(51) Int. Cl. A23N 7/02; A23N 7/10

(52) U.S. Cl. CPC A23N 7/023; A23N 7/10

(57) ABSTRACT

Described is an apparatus for peeling a mango which includes: a frame defining a seat designed to receive a mango to be peeled; an operating element projecting in the seat and designed to constitute a pivot of rotation for a mango; a handling device having an operating surface designed to interfere with the peel of a mango for exerting on it a traction by friction; the handling device facing the operating element in such a way that a passage for a mango is defined between them; drive means connected to the operating surface to operate it according to a movement designed to force a mango against the operating element and through the passage; elastic means designed to oppose the distancing of the operating element from the operating surface in order to elastically adapt the width of the passage to a mango; a blade placed in the passage and spaced from the operating surface in order to remove a surface layer of the mango.

### CROSS-REFERENCE TO RELATED APPLICATIONS

This application is the U.S. National Phase under 35 U.S.C. § 371 of International Application PCT/IT2018/050206, filed Oct. 24, 2018, which claims priority to IT Application No. 102017000121906, filed Oct. 26, 2017, the entire contents of each of which are incorporated by reference herein and made a part of this specification.

### SUMMARY

This invention relates to an apparatus for peeling a mango.

More specifically, the invention relates to an apparatus which is able to remove the peel from half of a mango in a single peeling operation.

In the field of machines for peeling a mango there is currently a prior art machine which comprises a support for a mango designed to hold it and rotate it about an axis of rotation.

The machine is equipped with a blade, supported by an arm, which places it in contact with the peel of the mango whilst this is rotated.

The blade is shaped in order to interfere tangentially with the peel of the mango in order to remove a surface layer from it.

The arm is translated along the axis of rotation of the mango in such a way as to obtain the peeling of the mango by means of an action similar to a circumferential turning.

This machine for peeling mangos has the drawback of being fragile and bulky, as well as having an unsatisfactory productivity.

The problem at the base of this invention is that of proposing an apparatus for peeling a mango which improves the productivity and structural solidity with respect to the traditional machine which was described above.

The main purpose of the present invention is to make an apparatus for peeling a mango which provides a solution to the above-mentioned problem by overcoming the perceived drawbacks of the above-mentioned machine.

In the scope of this objective, an aim of the present invention is to provide an apparatus for peeling a mango which allows a greater quantity of peel of the mango to be removed in the same processing time and with the same processing efficiency.

Another aim of the invention is to make an apparatus for peeling a mango which is robust and reliable.

Another aim of the invention is to provide an apparatus for peeling a mango which has an easy maintenance and is simple to adjust.

This task, as well as these and other aims which will emerge more fully below, are attained by an apparatus for peeling a mango according to the accompanying claim 1.

Detailed characteristics of an apparatus for peeling a mango according to the invention are indicated in the corresponding dependent claims.

### BRIEF DESCRIPTION OF THE DRAWINGS

Further characteristics and advantages of the invention will emerge more fully from the description of a preferred but not exclusive embodiment of an apparatus for peeling a mango according to the invention, illustrated by way of non-limiting example, in the appended drawings, in which:

FIG. 1 illustrates a perspective view of an apparatus for peeling a mango according the invention;

FIG. 2 illustrates a plan view from above of the apparatus of FIG. 1;

FIGS. 3a, 3b and 3c illustrate simplified diagrams of a detail of the apparatus of FIGS. 1 and 2 in successive operational steps;

FIG. 4 illustrates a simplified diagram of a plan view from above of the detail of FIG. 3b;

FIG. 5 illustrates a detail of the apparatus of FIGS. 1 and 2 cross-sectioned along the plane IV-IV of FIG. 2;

FIG. 6 illustrates an enlarged detail of the apparatus shown in FIG. 5.

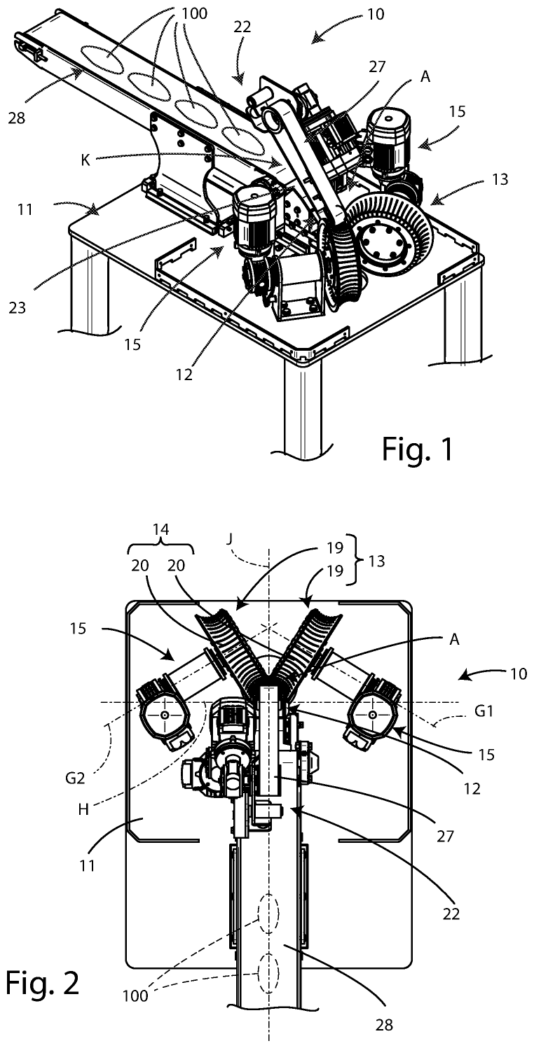

### DETAILED DESCRIPTION

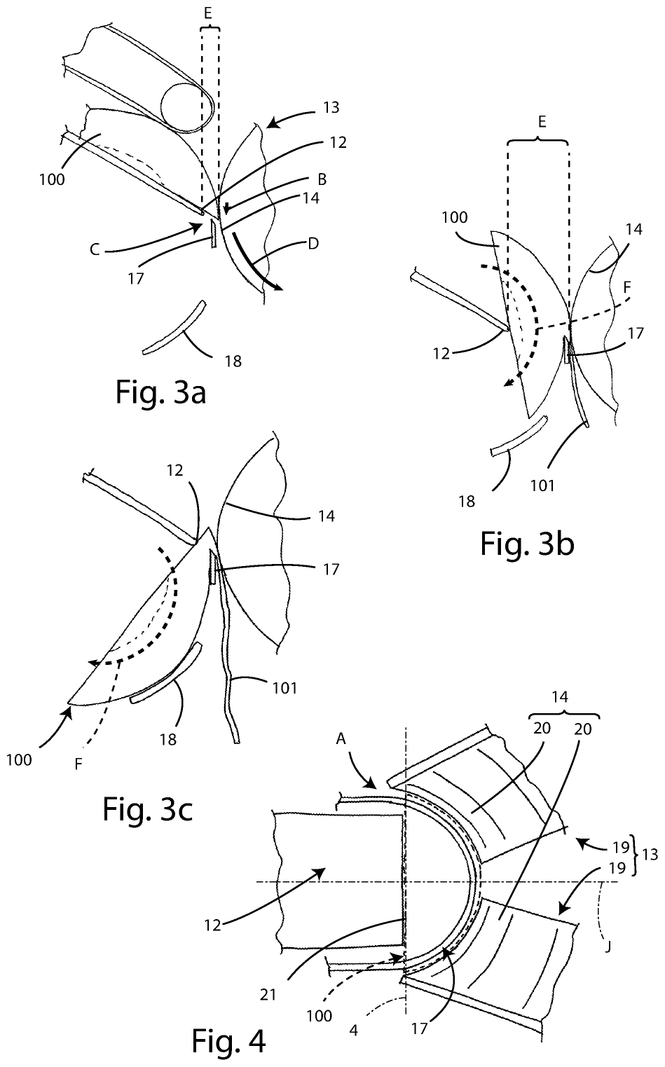

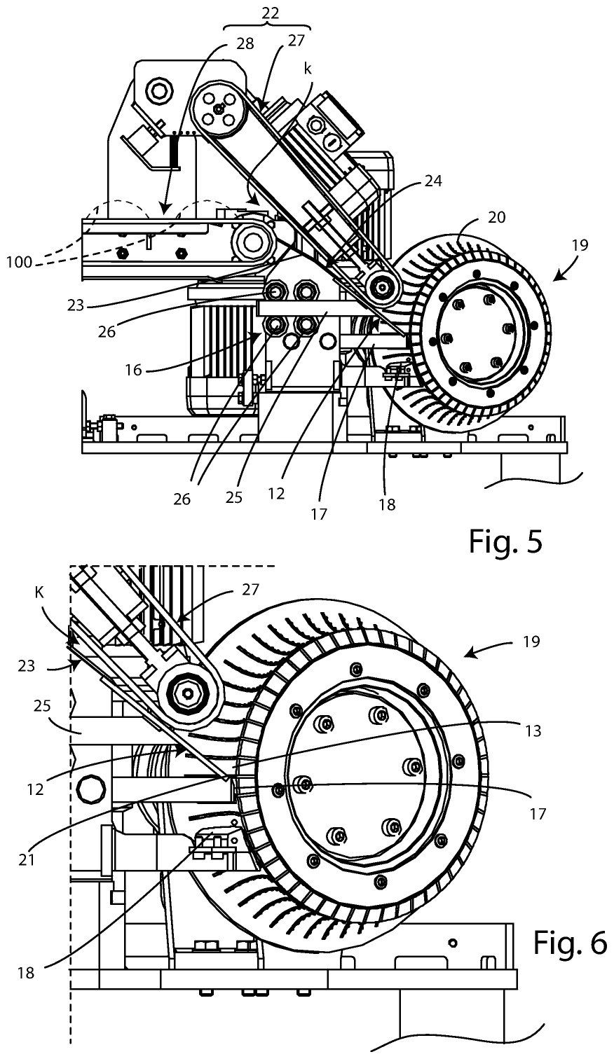

With particular reference to the above-mentioned drawings, reference numeral 10 denotes in its entirety an apparatus for peeling a mango 100 which according to the invention comprises:
a frame 11 having a seat A designed to receive a mango 100 to be peeled;
an operating element 12 projecting in the seat A and designed to constitute a pivot of rotation for a mango 100;
a handling device 13 having an operating surface 14 designed to interfere with the peel 101 of a mango 100 for exerting on it a traction B by friction; the handling device 13 faces the operating element 12 in such a way that a passage C for a mango 100 is defined between the operating element 12 and the handling device 13;
drive means 15 connected to the operating surface 14 to operate it according to a movement D designed to force a mango 100 against the operating element (12) and through the passage C, in order to rotate the mango 100 around the operating element 12 while the mango 100 passes through the passage C, as shown, for example, in FIGS. 3a-3c;
elastic means 16 designed to oppose the distancing of the operating element 12 from the operating surface 14 in order to elastically adapt the width E of the passage C to the overall size of a mango 100;
a blade 17 placed in the passage C and spaced from the operating surface 14 in order to remove a surface layer of the mango 100, which comprises the peel 201.

The apparatus is able to remove a surface layer from the mango 100, for the entire length of the mango 100, by means of a single passage through the passage C.

In this way, in the preferred case wherein the blade is shaped for removing the peel from half of a mango, by the passage through the passage C, half of the peel is removed.

The apparatus 10 therefore enables the productivity of mango peeling to be increased dramatically with respect to the traditional machine described above.

Tests on a prototype of the apparatus 10 have shown that it is possible to obtain a productivity of approximately 150 mango halves peeled per minute.

In general, the apparatus 10 may be fed with a series of whole mangos, however, preferably, they are fed with a series of mango halves with the stones removed, as shown by way of example in FIGS. 3a-3c.

In that case, each mango half can be completely peeled by the apparatus 10 in a single passage through the passage C.

FIG. 4 shows by way of an example, with a dashed line, the cross section of a half-mango which is intercepted by the blade 17.

In order to peel the half of a mango, the blade 17 advantageously extends along a concave trajectory with respect to the operating element 12 and it is shaped to remove the peel 101 from half of a mango 100 following a single passage of the mango 100 through the passage C.

Preferably, the apparatus 10 also comprises a guide element located downstream of the passage C to be engaged by a mango 100 which, in use, is pushed through the passage C by the operating surface 14.

The guide element 18 is advantageously shaped for guiding the mango 100 according to a trajectory F which is concave with respect to the operating element 12, for guiding the mango 100 to interfere with the blade 17 according to the curvature of the outer surface of the mango 100, so as to peel it efficiently.

The handling device 13 advantageously comprises at least one wheel 19 provided with a circumferential surface 20 which defines the operating surface 14.

According to a preferred but non-limiting embodiment of the apparatus 10, the handling device comprises two wheels 13 which advantageously have axes of rotation G1 and G2 forming an angle of between 90° and 135° and preferably equal to approximately 120°.

Preferably, the circumferential surface 20 of each wheel 19 has a concave profile, viewed according to a meridian section of the wheel 19, for engaging efficiently the peel of a mango 100.

In order to efficiently peel half of the mango, the operating element 12 preferably has an edge 21 which is substantially rectilinear so as to be engageable by the flat part deriving from the cutting of a mango 100 and defining for this a tilting axis H.

Alternatively, according to a possible embodiment of the apparatus, designed for the peeling of a whole mango, the edge 21 may be concave to define a tilting fulcrum which can be engaged by a side of mango whilst the opposite side is peeled by the blade 17.

In order to obtain a precise peeling, the axis of rotation G1, G2 of each wheel 19 is preferably coplanar with the tilting axis H.

For structural simplicity and stability of the apparatus 10, the axes of rotation G1, G2 of the two wheels 19 are advantageously mutually coplanar and substantially symmetrical with respect to a plane perpendicular to the tilting axis H.

Advantageously, the apparatus 10 also comprises a feed device 22 designed to feed a mango 100 in the seat A and to force it against the operating surface 14.

According to a preferred but non-limiting embodiment of the invention, the feed device 22 comprises a chute 23 inclined towards the seat A.

In that case, the operating element 12 will be shaped to constitute a continuation of the chute 23 for guiding a mango 100, or a half of a mango 100, up to the operating surface 14.

The chute 23 and the operating element 12 will have a support surface 24 in the case of peeling a half of a mango, or concave, in the case of peeling a whole mango.

The operating element 12 advantageously comprises a support 25 mounted on a guide unit 26 fixed to the frame 11.

Advantageously, the guide unit comprises a plurality of rollers 26 engaged by the support 25 and which define for the latter a sliding direction which is preferably directed towards the operating surface 14.

The above-mentioned elastic means preferably comprise at least one spring connected to the support 25 and to the frame 11 for elastically opposing the moving away of the edge 21 from the operating surface.

The feed device 22 to obtain a precise and timed feeding of mangos 100, advantageously also comprises a drive device 27, superposed on the chute 23 so as to delimit in cooperation with the latter a channel K for feeding mangos 100 towards the seat A.

Preferably, the drive device 27 comprises a first conveyor belt.

Advantageously, the drive device 27 can be spaced with respect to the chute 23 to adapt the width of the channel K to the overall size of a mango which passes through it.

In that case, the first conveyor belt is preferably tiltable with respect to the chute 23 and preferably is pivoted to the frame 11 and to a relative end distal with respect to the seat A.

The feed device advantageously also comprises a second conveyor belt 28 located upstream of the chute 23 for feeding the latter with mangos to be peeled.

Advantageously, the apparatus 10 is configured in such a way that the mutual position of the operating element 12, of the blade 17 and/or of the operating surface 14 is adjustable.

For example, the wheels 19 can be mounted on a support unit which is movable with respect to the frame 11 so as to be able to adjust their position with respect to the blade 17 and the operating element 12. This in particular allows the thickness of the surface layer of the mango 100 which is removed during peeling to be defined.

Operationally, with reference to the accompanying drawings, in order to peel a series of half mangos 100 with the stones removed, these are positioned on the second conveyor belt 28 with the cut face engaging it.

Preferably, the mangos 100 are oriented in such a way that their main axis of extension is parallel to the feed direction defined by the second conveyor belt 28.

The latter, in use, transfers the mangos 100 to be cut to the chute 23 along which these are slid by the action of the first conveyor belt or, in general, by the drive device, until reaching the seat A.

Here, the operating surface 14, when moving, engages the peel of the mango 100 and draws the latter into the passage C thus rotating the latter about the edge 21 so that the blade 17 cuts the mango 100 superficially, removing a surface layer following the feeding of the mango 100 in the passage C and simultaneous rotation about the tilting axis H.

The rotation of the mango 100 is also guided by the guide element 18 which guarantees that the rotation also continues when the mango is almost completely peeled.

Advantageously, the apparatus 10 comprises two separate discharge conduits, not illustrated, of which a first designed to convey the peeled mangos into a first container and second designed to convey the peels into a second container.

The invention as it is conceived is susceptible to numerous modifications and variants, all falling within the scope of protection of the appended claims.

Further, all the details can be replaced by other technically-equivalent elements.

In practice, the materials used, as well as the contingent shapes and dimensions, can be varied according to the contingent requirements and the state of the art.

Where the constructional characteristics and the technical characteristics mentioned in the following claims are followed by signs or reference numerals, the signs or reference numerals have been used only with the aim of increasing the intelligibility of the claims themselves and, consequently, they do not constitute in any way a limitation to the interpretation of each identified element, purely by way of example, by the signs or reference numerals.

1. An apparatus for peeling a mango, the apparatus comprising:
a frame defining a seat adapted to receive a mango to be peeled;
an operating element projecting in said seat and adapted to constitute a pivot of rotation for a mango;
a handling device having an operating surface adapted to interfere with the peel of a mango, exerting on it a traction by friction; said handling device faces said operating element in such a way that between said operating element and said handling device a passage is defined for a mango;
drive means connected to said operating surface to operate it according to a movement adapted to force a mango against said operating element and through said passage, to rotate said mango around said operating element while said mango passes through said passage;
elastic means adapted to oppose the distancing of said operating element from said operating surface in order to elastically adapt the width of said passage to a mango; and
a blade placed in said passage and spaced from said operating surface in order to remove a surface layer from said mango.

2. The apparatus according to claim 1, wherein blade extends along a concave trajectory with respect to said operating element and shaped to remove the peel from half of a mango following a single passage of said mango through said passage.

3. The apparatus according to claim 1, further comprising a guide element arranged downstream of said passage to be engaged by a mango pushed through said passage by said operating surface, wherein said guide element is shaped to guide said mango according to a concave trajectory with respect to said operating element to guide said mango to interfere with said blade according to the curvature of the external surface of said mango.

4. The apparatus according to claim 1, wherein said handling device comprises at least a wheel provided with a circumferential surface which defines said operating surface.

5. The apparatus according to claim 4, wherein said circumferential surface has a concave profile.

6. The apparatus according to claim 4, wherein said operating element has a substantially rectilinear edge that can be engaged by a mango and thereby defines an axis of tilting.

7. The apparatus according to claim 4, wherein the axis of rotation of said at least wheel is coplanar with respect to said axis of tilting.

8. The apparatus according to claim 4, wherein said handling device comprises two of said wheel, each having a corresponding axis of rotation, wherein the axes of rotation of said two wheels being mutually coplanar and substantially symmetrical with respect to a plane perpendicular to said axis of tilting.

9. The apparatus according to claim 1, further comprising a supply device for feeding a mango into said seat and forcing it against said operating surface.
